(19) United States
(12) Patent Application Publication
(10) Pub. No.: US 2018/0362276 A1
(43) Pub. Date: Dec. 20, 2018

(54) BELT CONVEYING APPARATUS AND IMAGE FORMING APPARATUS

(71) Applicant: KONICA MINOLTA, INC., Tokyo (JP)

(72) Inventors: Masayuki Satou, Toyohashi-shi (JP); Tomoyoshi Yukimoto, Nagoya-shi (JP); Taisuke Minemura, Okazaki-shi (JP); Yoshiyuki Toso, Toyokawa-shi (JP)

(73) Assignee: KONICA MINOLTA, INC., Tokyo (JP)

(21) Appl. No.: 16/009,284

(22) Filed: Jun. 15, 2018

(30) Foreign Application Priority Data
Jun. 20, 2017 (JP) 2017-120756

(51) Int. Cl. B65H 5/02; G03G 15/00

(52) U.S. Cl. CPC B65H 5/021; G03G 2215/00556; G03G 15/6529

(57) ABSTRACT

A belt conveying apparatus includes: an endless belt member; a belt conveying roller that rotatably stretches the belt member; a pair of regulating members, disposed at both end parts of the belt conveying roller, that regulates movement of the belt member in a width direction thereof; a moving mechanism that moves at least one of the pair of regulating members in the width direction; and a supporting member that supports the belt member in an area extending in the width direction after the regulating member has moved.

The entire disclosure of Japanese patent Application No. 2017-120756, filed on Jun. 20, 2017, is incorporated herein by reference in its entirety.

### BACKGROUND

### Technological Field

The present invention relates to a belt conveying apparatus and an image forming apparatus.

### Description of the Related Art

Generally, an image forming apparatus (printer, copying machine, facsimile, and the like) using the electrophotographic process technology forms an electrostatic latent image by irradiating a charged photosensitive drum (image carrier) with a laser beam based on image data (that is, by exposing a charged photosensitive drum to a laser beam). Then, the electrostatic latent image is visualized to form a toner image by supply of toner from a developing device to the photosensitive drum on which the electrostatic latent image has been formed. Furthermore, after the toner image is directly or indirectly transferred to a paper sheet, heat and pressure are applied thereto at a fixing nip to fix and form the toner image on the paper sheet.

For example, when paper sheets of the same size consecutively pass through a fixing belt (belt member) in a fixing device of the belt fixing type, an edge scratch is caused, on the surface of the fixing belt, by a burr existing on an edge of the paper sheet along a paper conveying direction or by the thickness of the paper sheet. The edge scratch is a trace of the paper sheet edge. The edge scratch causes an image noise, such as unevenness of gloss, in the image formed on the paper sheet.

In order to reduce an image noise caused by such an edge scratch, there is used a general technique of moving the entire fixing device in a width direction orthogonal to the paper conveying direction especially in the production printing field. Edge scratches of the fixing belt can be prevented by the movement since the edge along the paper conveying direction and the fixing belt do not come into contact with each other at a fixed position, as a result of the movement.

However, a device for moving the fixing device causes an increase in cost, in addition to an increase in occupied volume in the image forming apparatus. Therefore, it is desirable to prevent edge scratches from being caused on the fixing belt in a space-saving manner at low cost.

For example, JP 2012-47848 A discloses a technique of moving a belt conveying roller that stretches a fixing belt. The technique prevents edge scratches from being caused on the fixing belt by moving the belt conveying roller instead of the main body of the fixing device.

In addition, JP 2015-81946 A discloses a technique of moving, in a width direction of a free belt, a pair of regulating members that regulates the movement of the free belt in its width direction. The pair of regulating members is disposed at both end parts of the free belt.

However, in the configuration described in JP 2012-47848 A, the position of the center of gravity of each roller constituting the fixing device relatively changes since the belt conveying roller is moved. Therefore, differences in parallelism occur among the respective rollers, and eventually, the fixing belt largely shifts its position in the width direction. This may cause the fixing belt to be damaged.

Meanwhile, since the configuration described in JP 2015-81946 A adopts the pad fixing system, the above-described problem is unlikely to occur. However, when the regulating members are moved after being attached to the belt conveying roller of the belt fixing type, a space is created between the regulating members and the belt conveying roller. Thus, the fixing belt may be buckled and damaged by entering the space.

### SUMMARY

An object of the present invention is to provide a belt conveying apparatus and an image forming apparatus capable of preventing a belt member from being damaged due to a movement of the belt member in a width direction thereof while maintaining the parallelism of a belt conveying roller.

To achieve the abovementioned object, according to an aspect of the present invention, a belt conveying apparatus reflecting one aspect of the present invention comprises: an endless belt member; a belt conveying roller that rotatably stretches the belt member; a pair of regulating members, disposed at both end parts of the belt conveying roller, that regulates movement of the belt member in a width direction thereof; a moving mechanism that moves at least one of the pair of regulating members in the width direction; and a supporting member that supports the belt member in an area extending in the width direction after the regulating member has moved.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing the entire configuration of an image forming apparatus according to the present embodiment;

FIG. 2 is a diagram showing a main part of a control system of the image forming apparatus according to the present embodiment;

FIG. 3 is a perspective view of an end part of a heating roller;

FIG. 4 is an exploded view of the end part of the heating roller;

FIG. 5 is a view showing the heating roller and a moving mechanism;

FIG. 6 is an enlarged view of a contact part between a regulating member and a supporting member of a fixing belt;

FIGS. 7A and 7B are views for describing how the fixing belt buckles;

FIG. 8 is a sectional view of a relatively large level difference between a main body and a throttle part of the heating roller;

FIG. 9 is a sectional view of a relatively small level difference between the main body and the throttle part of the heating roller;

FIG. 10 is an enlarged view of a regulating comb-teeth part and a supporting comb-teeth part according to a first variation;

FIG. 11 is a sectional view of the regulating comb-teeth part and the supporting comb-teeth part according to the first variation;

FIG. 12 is an enlarged view of a regulating comb-teeth part and a supporting comb-teeth part according to a second variation;

FIG. 13 is an enlarged view of a regulating comb-teeth part and a supporting comb-teeth part according to a third variation;

FIG. 14 is an enlarged view of a regulating comb-teeth part and a supporting comb-teeth part according to a fourth variation;

FIGS. 15A and 15B are views showing a regulating member and a supporting member according to a fifth variation; and

FIGS. 16A and 16B are views for describing the operation of a regulating member and a supporting member according to a sixth variation.

### DETAILED DESCRIPTION OF EMBODIMENTS

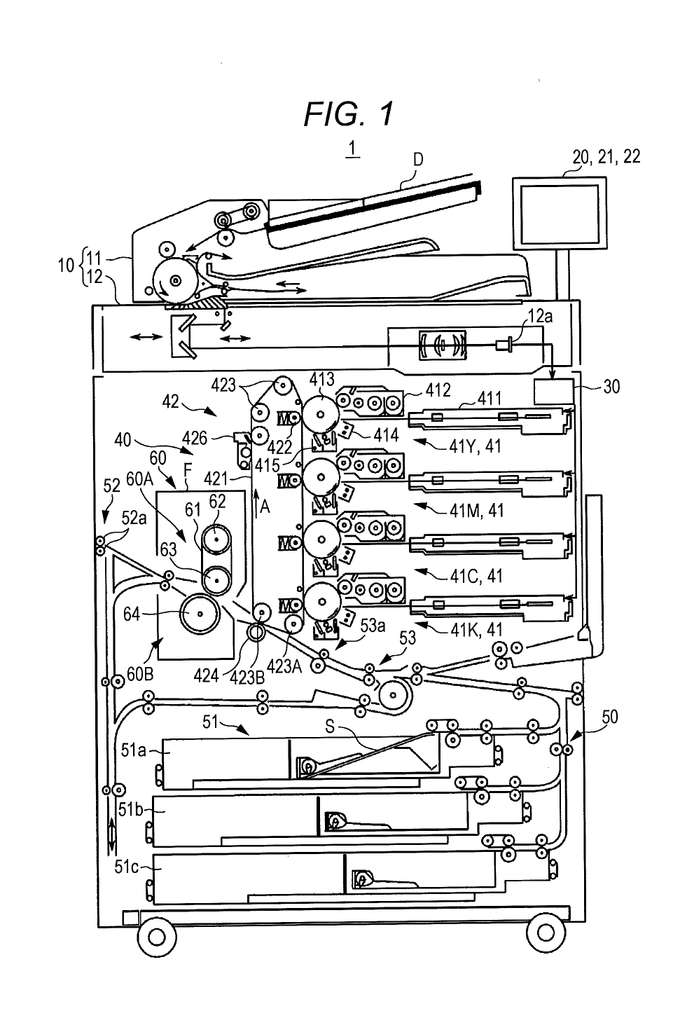

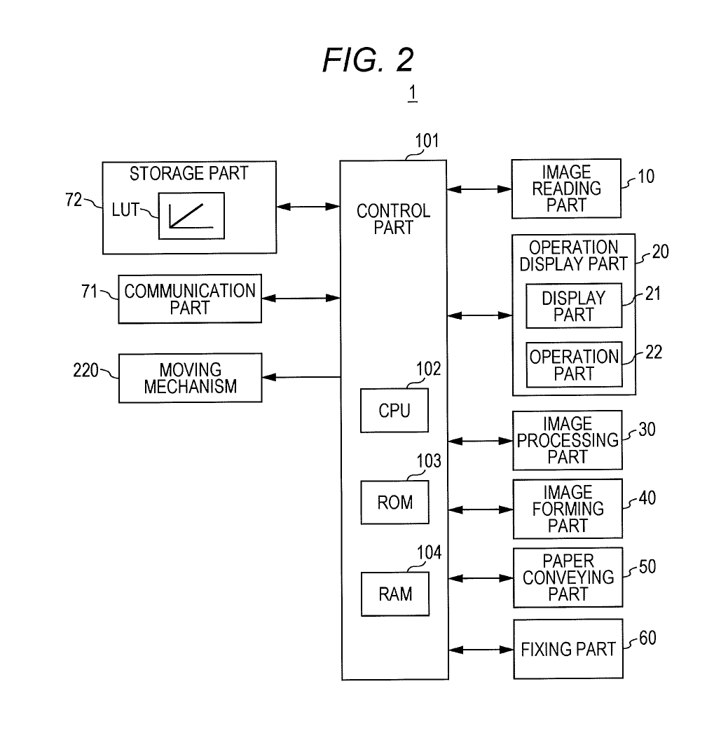

Hereinafter, one or more embodiments of the present invention will be described in detail with reference to the drawings. However, the scope of the invention is not limited to the disclosed embodiments. FIG. 1 is a diagram schematically showing the entire configuration of an image forming apparatus 1 according to the present embodiment. FIG. 2 is a diagram showing a main part of a control system of the image forming apparatus 1 according to the present embodiment.

As shown in FIG. 1, the image forming apparatus 1 is an intermediate transfer type color image forming apparatus using the electrophotographic process technology. That is, the image forming apparatus 1 forms an image as follows. Respective color toner images of yellow (Y), magenta (M), cyan (C), and black (K) formed on photosensitive drums 413 are primarily transferred to an intermediate transfer belt 421, and superimposed thereon. Then, the superimposed four-color toner images are secondarily transferred to a paper sheet S sent from paper feed tray units 51a to 51c, to form an image.

Additionally, the image forming apparatus 1 adopts the tandem system. In the tandem system, the photosensitive drums 413 corresponding to the four colors of Y, M, C, and K are arranged in series in a running direction of the intermediate transfer belt 421, and the toner images of the respective colors are sequentially transferred to the intermediate transfer belt 421 in a single step.

As shown in FIG. 2, the image forming apparatus 1 includes an image reading part 10, an operation display part 20, an image processing part 30, an image forming part 40, a paper conveying part 50, a fixing part 60, and a control part 101. The fixing part 60 corresponds to the “belt conveying apparatus” of the present invention.

The control part 101 includes a central processing unit (CPU) 102, a read only memory (ROM) 103, a random access memory (RAM) 104, and the like. The CPU 102 reads a program from the ROM 103 in accordance with processing details, and expands the program in the RAM 104. In cooperation with the expanded program, the CPU 102 controls the operation of, for example, each block of the image forming apparatus 1 in a centralized manner. Then, various data stored in a storage part 72 are referred to. The storage part 72 includes, for example, a nonvolatile semiconductor memory (so-called flash memory) and a hard disk drive.

The control part 101 transmits/receives various data, via a communication part 71, to/from an external device (for example, a personal computer) connected to a communication network such as a local area network (LAN) and a wide area network (WAN). The control part 101 receives, for example, image data (input image data) transmitted from the external device, and causes an image to be formed on the paper sheet S based on the image data. The communication part 71 includes, for example, a communication control card such as a LAN card.

As shown in FIG. 1, the image reading part 10 includes an automatic document feeding device 11 called an auto document feeder (ADF), an original image scanning device 12 (scanner), and the like.

The automatic document feeding device 11 conveys a document D placed on a document tray by means of a conveyance mechanism, and sends the document D to the original image scanning device 12. It is possible to consecutively read, at a time, images (including both sides) of the document D containing multiple sheets placed on the document tray, by means of the automatic document feeding device 11.

The original image scanning device 12 optically scans a document conveyed from the automatic document feeding device 11 to a contact glass or a document placed on the contact glass. Then, the original image scanning device 12 causes light reflected from the document to form an image on a light receiving surface of a charge coupled device (CCD) sensor 12a to read an original image. The image reading part 10 generates input image data based on a reading result by the original image scanning device 12. The input image data are subjected to predetermined image processing in the image processing part 30.

As shown in FIG. 2, the operation display part 20 includes, for example, a liquid crystal display (LCD) with a touch panel, and functions as a display part 21 and an operation part 22. The display part 21 displays various operation screens, image conditions, operating states of respective functions, and the like, in accordance with a display control signal input from the control part 101. The operation part 22 includes various operation keys such as a numeric keypad and a start key. The operation part 22 accepts various input operations by a user, and outputs an operation signal to the control part 101.

The image processing part 30 includes a circuit and the like for performing digital image processing on the input image data in accordance with an initial setting or user setting. For example, the image processing part 30 performs tone correction based on tone correction data (tone correction table) under the control of the control part 101. In addition to the tone correction, the image processing part 30 applies, to the input image data, various correction processing, such as color correction and shading correction, compression processing, and the like. The image forming part 40 is controlled based on the image data subjected to the above-described processing.

As shown in FIG. 1, the image forming part 40 includes image forming units 41Y, 41M, 41C, and 41K, an intermediate transfer unit 42, and the like. Based on the input image data, the image forming units 41Y, 41M, 41C, and 41K form images with respective color toners of Y, M, C, and K components.

The image forming units 41Y, 41M, 41C, and 41K intended for Y, M, C, and K components, respectively, have similar configurations. For convenience of illustration and description, common constituent elements are denoted by the same reference signs. When the common constituent elements are to be distinguished from one another, Y, M, C, or K is to be added to the reference signs. In FIG. 1, only the constituent elements of the image forming unit 41Y intended for the Y component are denoted by reference signs. Reference signs have been omitted for the constituent elements of the other image forming units 41M, 41C, and 41K.

The image forming unit 41 includes an exposure device 411, a developing device 412, the photosensitive drum 413, a charging device 414, a drum cleaning device 415, and the like.

The photosensitive drum 413 is made of, for example, an organic photoreceptor with a photosensitive layer formed, of a resin containing an organic photoconductor, on the outer peripheral surface of a drum-shaped metal substrate.

The control part 101 rotates the photosensitive drum 413 at a constant peripheral velocity by controlling a driving current supplied to a driving motor (not shown) that rotates the photosensitive drum 413.

The charging device 414 is, for example, an electrification charger, and uniformly charges the surface of the photosensitive drum 413, which has photoconductivity, to the negative polarity by generating a corona discharge.

The exposure device 411 includes, for example, a semiconductor laser, and irradiates the photosensitive drum 413 with laser beams corresponding to images of the respective color components. As a result, an electrostatic latent image of each color component is formed in an image area irradiated with the laser beam on the surface of the photosensitive drum 413 due to a potential difference from a background area.

The developing device 412 is a developing device of the two-component reverse rotation type. The developing device 412 visualizes the electrostatic latent image to form a toner image by causing a developer of each color component to adhere to the surface of the photosensitive drum 413.

A developing bias is applied to the developing device 412. Examples of the developing bias include a DC developing bias of the same polarity as the charging polarity of the charging device 414, and a developing bias of a DC voltage, which has the same polarity as the charging polarity of the charging device 414, superimposed on an AC voltage. As a result, reversal development is performed. That is, the toner is caused to adhere to the electrostatic latent image formed by the exposure device 411.

The drum cleaning device 415 is in contact with the surface of the photosensitive drum 413, and has a tabular drum cleaning blade or the like made of an elastic body. The drum cleaning device 415 removes the toner which is remaining on the surface of the photosensitive drum 413 without being transferred to the intermediate transfer belt 421.

The intermediate transfer unit 42 includes the intermediate transfer belt 421, a primary transfer roller 422, a plurality of supporting rollers 423, a secondary transfer roller 424, a belt cleaning device 426, and the like.

The intermediate transfer belt 421 is formed of an endless belt, and is stretched around the plurality of supporting rollers 423 in a loop shape. The plurality of supporting rollers 423 includes at least one driving roller and driven rollers as the rest. For example, it is preferable that the driving roller is used as a roller 423A disposed downstream of the primary transfer roller 422 for the K component in the belt running direction. Thus, it is possible to easily maintain, at a constant level, the speed of the belt running at a primary transfer part. As the driving roller 423A rotates, the intermediate transfer belt 421 runs at a constant speed in the direction of an arrow A.

The intermediate transfer belt 421 is an electrically-conductive and elastic belt with a high-resistivity layer on its surface. The intermediate transfer belt 421 is rotationally driven by a control signal from the control part 101.

The primary transfer rollers 422 are disposed on the inner peripheral surface side of the intermediate transfer belt 421 in a manner to face the photosensitive drums 413 of the respective color components. As the primary transfer roller 422 is pressed against the photosensitive drum 413 with the intermediate transfer belt 421 interposed therebetween, a primary transfer nip is formed for transferring the toner image from the photosensitive drum 413 to the intermediate transfer belt 421.

The secondary transfer roller 424 is disposed on the outer peripheral surface side of the intermediate transfer belt 421 in a manner to face a backup roller 423B disposed downstream of the driving roller 423A in the belt running direction. As the secondary transfer roller 424 is pressed against the backup roller 423B with the intermediate transfer belt 421 interposed therebetween, a secondary transfer nip is formed for transferring the toner image from the intermediate transfer belt 421 to the paper sheet S.

When the intermediate transfer belt 421 passes through the primary transfer nip, the toner images on the photosensitive drums 413 are primarily transferred to the intermediate transfer belt 421 while being sequentially superimposed on the intermediate transfer belt 421. Specifically, the toner image is electrostatically transferred to the intermediate transfer belt 421 by a primary transfer bias being applied to the primary transfer roller 422 so as to apply a charge having a polarity opposite to that of the toner, to the back side of the intermediate transfer belt 421, that is, the side in contact with the primary transfer roller 422.

Subsequently, when the paper sheet S passes through the secondary transfer nip, the toner image on the intermediate transfer belt 421 is secondarily transferred to the paper sheet S. Specifically, the toner image is electrostatically transferred to the paper sheet S by a secondary transfer bias being applied to the secondary transfer roller 424 so as to apply a charge having a polarity opposite to that of the toner, to the back side of the paper sheet S, that is, the side in contact with the secondary transfer roller 424. The paper sheet S to which the toner image has been transferred is conveyed toward the fixing part 60.

The belt cleaning device 426 removes the transfer residual toner remaining on the surface of the intermediate transfer belt 421 after the secondary transfer.

The fixing part 60 includes an upper fixing part 60A, a lower fixing part 60B, a heating source, and the like. The upper fixing part 60A has a fixing surface side member disposed on a fixing surface of the paper sheet S, that is, a side of the paper sheet S on which the toner image has been formed. The lower fixing part 60B has a back side supporting member disposed on the back side of the paper sheet S, that is, a side opposite to the fixing surface. As the back side supporting member is pressed against the fixing surface side member, a fixing nip is formed for clamping and conveying the paper sheet S.

The fixing part 60 fixes the toner image on the paper sheet S by applying, at the fixing nip, heat and pressure to the conveyed paper sheet S, on which the toner image has been secondarily transferred. The fixing part 60 is disposed as a unit in a fixing unit F.

The upper fixing part 60A has an endless fixing belt 61 which is the fixing surface side member, a heating roller 62, and a fixing roller 63. The fixing roller 63 is fixed to both side plates (not shown) via bearings. A tension is applied to the heating roller 62 in a direction away from the fixing roller 63.

The fixing belt 61 is stretched by the heating roller 62 and the fixing roller 63. The fixing belt 61 corresponds to the “belt member” of the present invention. The heating roller 62 corresponds to the “belt conveying roller” of the present invention. It should be noted that the thickness of the fixing belt 61 is, for example, 0.2 mm.

The lower fixing part 60B has a pressure roller 64 which is the back side supporting member. The pressure roller 64 forms the fixing nip which, together with the fixing belt 61, clamps and conveys the paper sheet S.

The paper conveying part 50 includes a paper feed part 51, a paper ejection part 52, a conveyance route part 53, and the like. The three paper feed tray units 51a to 51c, which are included in the paper feed part 51, store the paper sheets S (standard paper and special paper) distinguished based on their basis weight, size, and the like, for each type set in advance. The conveyance route part 53 has a plurality of conveying roller pairs including a registration roller pair 53a. The registration roller part, in which the registration roller pair 53a is disposed, corrects the inclination and deviation of the paper sheet S.

The paper sheets S stored in the paper feed tray units 51a to 51c are sent one by one from the uppermost parts thereof, and are conveyed to the image forming part 40 through the conveyance route part 53. The toner images on the intermediate transfer belt 421 are secondarily transferred, in a lump, to one side of the paper sheet S in the image forming part 40, and are subjected to a fixing process in the fixing part 60. The paper sheet S, on which an image has been formed, is ejected outside the apparatus by the paper ejection part 52 which includes paper ejection rollers 52a.

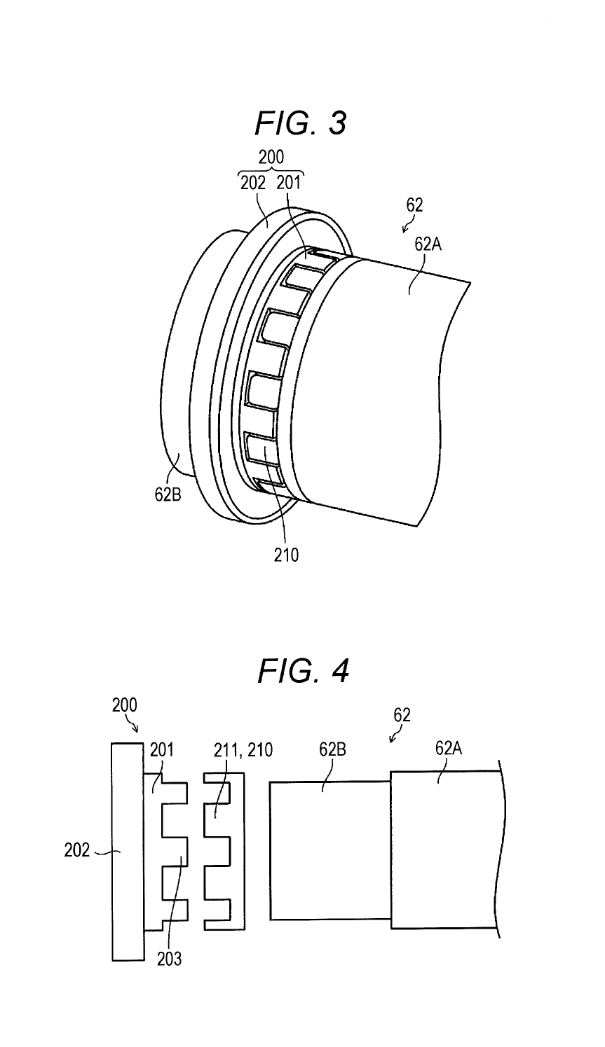

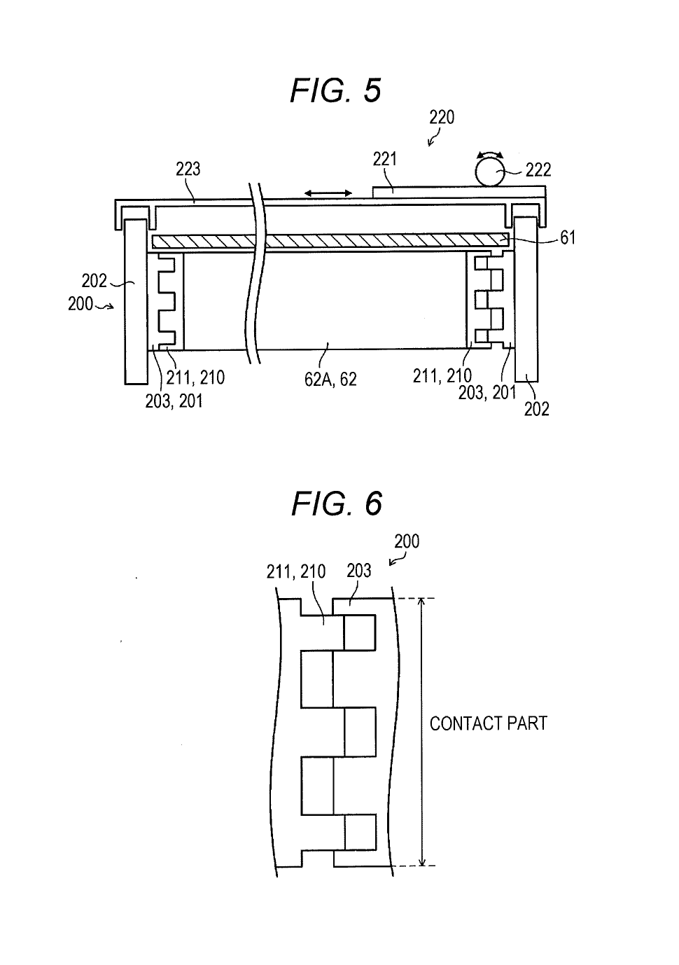

As shown in FIGS. 3 and 4, the fixing part 60 in the present embodiment includes a pair of regulating members 200, a pair of supporting members 210, and a moving mechanism 220 (see FIGS. 2 and 5). The pair of regulating members 200 and the pair of supporting members 210 are each provided at both end parts of the heating roller 62. It should be noted that since both end parts of the heating roller 62 are identically configured, only one of the end parts will be described, and a description of the other end part will be omitted.

The heating roller 62 is formed in a cylindrical shape, and includes a main body 62A and throttle parts 62B. The main body 62A extends in an axial direction (the width direction of the fixing belt 61). The throttle parts 62B are located at both axial end parts of the main body 62A. The diameter of the throttle part 62B is smaller than that of the main body 62A.

The pair of regulating members 200 regulates the movement of the fixing belt 61 in a width direction thereof (hereinafter referred to as the “width direction”). The pair of regulating members 200 is formed in an annular shape with a diameter larger than that of the throttle part 62B. The regulating members 200 are provided, in a movable manner, on the respective throttle parts 62B located at both end parts of the main body 62A.

The regulating member 200 includes a small diameter part 201 and a large diameter part 202 with an outer diameter larger than that of the small diameter part 201. The outer diameter of the small diameter part 201 is substantially equal to that of the main body 62A. The large diameter part 202 is located on the opposite side of the main body 62A with respect to the small diameter part 201.

The fixing belt 61 moves in the width direction due to various factors such as the accuracy of parallelism of the fixing roller 63 and the heating roller 62, the circular runout accuracy of each roller, and an uneven pressure applied at the fixing nip. Even if the fixing belt 61 moves in the width direction, the regulating member 200 regulates the movement of the fixing belt 61 by the large diameter part 202 coming into contact with the fixing belt 61. Therefore, it is possible to prevent the fixing belt 61 from being damaged due to the movement of the fixing belt 61 in the width direction while maintaining the parallelism of the heating roller 62.

The pair of supporting members 210 is formed in an annular shape with an outer diameter which is larger than that of the throttle part 62B and substantially equal to that of the main body 62A. Each of the supporting members 210 is disposed on the side of the main body 62A relative to the regulating member 200 provided on each of the throttle parts 62B.

The small diameter part 201 and the supporting member 210 are opposed to each other. A regulating comb-teeth part 203 is formed on a side of the small diameter part 201 which faces the supporting member 210. In addition, a supporting comb-teeth part 211 is formed on a side of the supporting member 210 which faces the regulating member 200.

The regulating comb-teeth part 203 and the supporting comb-teeth part 211 are formed in a manner capable of engaging with each other. Each tooth of the regulating comb-teeth part 203 and the supporting comb-teeth part 211 is formed in a rectangular shape.

As shown in FIG. 5, the moving mechanism 220 is a mechanism for moving the regulating member 200 under the control of the control part 101. The moving mechanism 220 includes a rack gear 221, a pinion gear 222, and a moving member 223. The rack gear 221 engages with the pinion gear 222, and moves in the width direction, which is the horizontal direction in the drawing, in accordance with the rotation of the pinion gear 222.

It should be noted that the pinion gear 222 can be driven by a driving source such as a pressing and separating motor for causing the fixing belt 61 and the pressure roller 64 to be pressed against or separated from each other, a motor for driving the entire image forming apparatus 1, and a motor dedicated for the moving mechanism 220.

The moving member 223 is formed in a plate shape, and moves integrally with the rack gear 221. The moving member 223 supports the large diameter parts 202 of the regulating members 200 at both end parts in the width direction. Therefore, as the moving member 223 moves, the regulating members 200 move in the width direction.

As shown in FIG. 6, when the regulating comb-teeth part 203 of one of the pair of regulating members 200 completely engages with the supporting comb-teeth part 211, the regulating comb-teeth part 203 of the other regulating member 200 partially engages with the supporting comb-teeth part 211, only at their tips.

In other words, at least either one of the regulating member 200 or the supporting member 210 is disposed within a range where the regulating member 200 and the supporting member 210 are disposed in the width direction.

As a result, it is possible to constantly arrange either the regulating member 200 or the supporting member 210 between the regulating member 200 and the supporting member 210.

Furthermore, the respective teeth of the regulating comb-teeth part 203 and those of the supporting comb-teeth part 211 are alternately arranged in the circumferential direction of the heating roller 62 (hereinafter referred to as the “circumferential direction”) which is the vertical direction in the drawing. That is, the interval between two adjacent teeth of the regulating comb-teeth part 203 and the interval between two adjacent teeth of the supporting comb-teeth part 211 are smaller than the circumferential length of a contact part between the fixing belt 61 and the heating roller 62.

As a result, it is possible to prevent the creation of a space, which the fixing belt 61 may enter, at the contact part between the heating roller 62 and the fixing belt 61 in the circumferential direction.

Meanwhile, for example, when paper sheets S of the same size consecutively pass through the fixing belt 61 in the fixing part 60 of the belt fixing type, an edge scratch is caused, on the surface of the fixing belt 61, by a burr existing on an edge of the paper sheet S along a conveying direction thereof or by the thickness of the paper sheet S. The edge scratch is a trace of the paper sheet edge. The edge scratch causes an image noise, such as unevenness of gloss, in the image formed on the paper sheet S.

Therefore, in the present embodiment, it is possible to prevent edge scratches from being caused on the fixing belt 61 since the pair of regulating members 200 is controlled, by the control part 101, so as to move in the width direction.

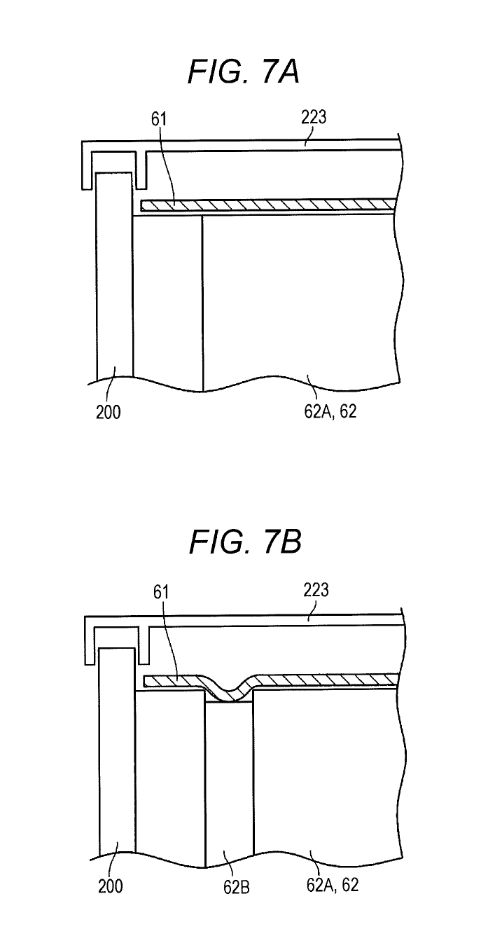

However, as shown in FIGS. 7A and 7B, when the regulating member 200 moves, the throttle part 62B is exposed between the main body 62A of the heating roller 62 and the regulating member 200. Since there are level differences between the main body 62A and the throttle part 62B and between the regulating member 200 and the throttle part 62B, there is a risk that the fixing belt 61 may buckle as a result of entering an area extending in the width direction on the throttle part 62B when the fixing belt 61 moves in the width direction.

However, in the present embodiment, the supporting member 210 for supporting the fixing belt 61 is provided between the regulating member 200 and the main body 62A so that the fixing belt 61 does not enter the area extending in the width direction after the regulating member 200 has moved, as shown in FIG. 5. In the area, spaces and the supporting member 210 are disposed in the circumferential direction of the heating roller 62 after the regulating member 200 has moved.

More specifically, since the regulating comb-teeth part 203 and the supporting comb-teeth part 211 are disposed in a manner to engage with each other, the supporting member 210 supports the fixing belt 61 without forming an area to allow the fixing belt 61 to enter in the circumferential direction. Therefore, it is possible to prevent the fixing belt 61 from entering a part around the throttle part 62B and buckling when the fixing belt 61 moves in the width direction.

In addition, when the fixing belt 61 is moved during fixation, the paper sheet S and the image are affected. Therefore, it is desirable to control the regulating member 200 in such a manner that the regulating member 200 is moved while the paper sheet S passes through the fixing nip, that is, during an interval between paper sheets passing, an image stabilization process, or the like. The amount of movement of the regulating member 200 may be, for example, 0.05 mm per single movement control. Furthermore, the maximum width of movement of the regulating member 200 may be, for example, 5 mm.

In addition, the supporting member 210 is formed of a resin or the like having sliding properties. In consideration of heat resistance and durability, polyphenylene sulfide (PPS), polyamide imide (PAI), or the like is used as a material for the supporting member 210. Moreover, the supporting member 210 may be coated with a fluororesin or the like having sliding properties. Thus, frictional resistance in the width-directional movement can be reduced while the fixing belt 61 is supported by the supporting member 210. Therefore, it is possible to efficiently move the fixing belt 61.

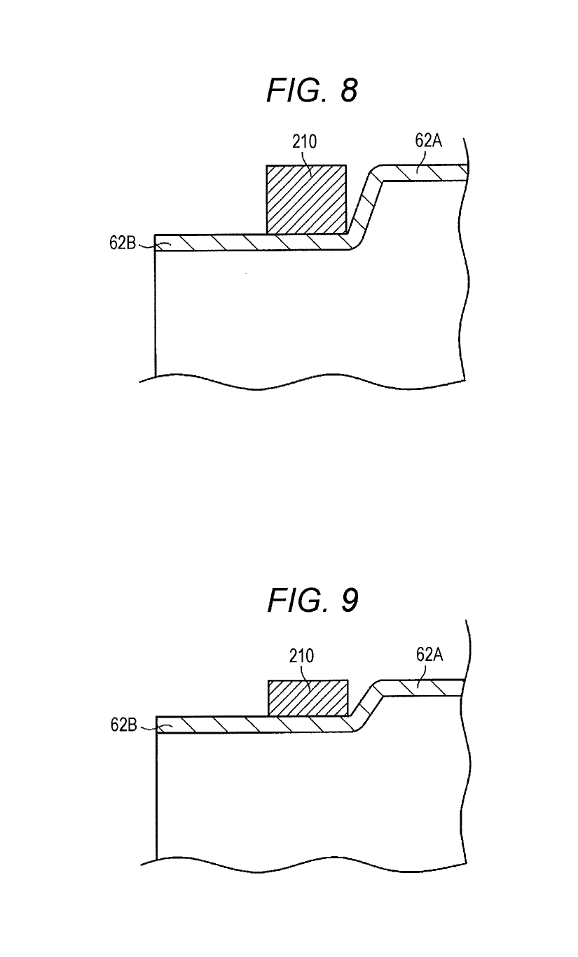

Additionally, the thickness of the supporting member 210 is determined according to the level difference between the main body 62A and the throttle part 62B. Therefore, for example, when the level difference between the main body 62A and the throttle part 62B is relatively large, as shown in FIG. 8, it is preferable to increase the thickness of the supporting member 210 in accordance with the level difference. Meanwhile, when the level difference between the main body 62A and the throttle part 62B is relatively small, as shown in FIG. 9, it is preferable to reduce the thickness of the supporting member 210 in accordance with the level difference.

Thus, it is possible to easily apply the present configuration by adjusting the thickness of the supporting member 210 even when the level difference between the main body 62A and the throttle part 62B is extremely small due to a reduction in cost of roller processing.

According to the present embodiment configured as described above, it is possible to prevent the fixing belt 61 from being damaged due to the movement of the fixing belt 61 in the width direction while maintaining the parallelism of the heating roller 62.

Furthermore, it is possible to prevent edge scratches from being caused on the fixing belt 61 in a space-saving manner at low cost by moving only the regulating member 200 without moving the entire fixing part 60.

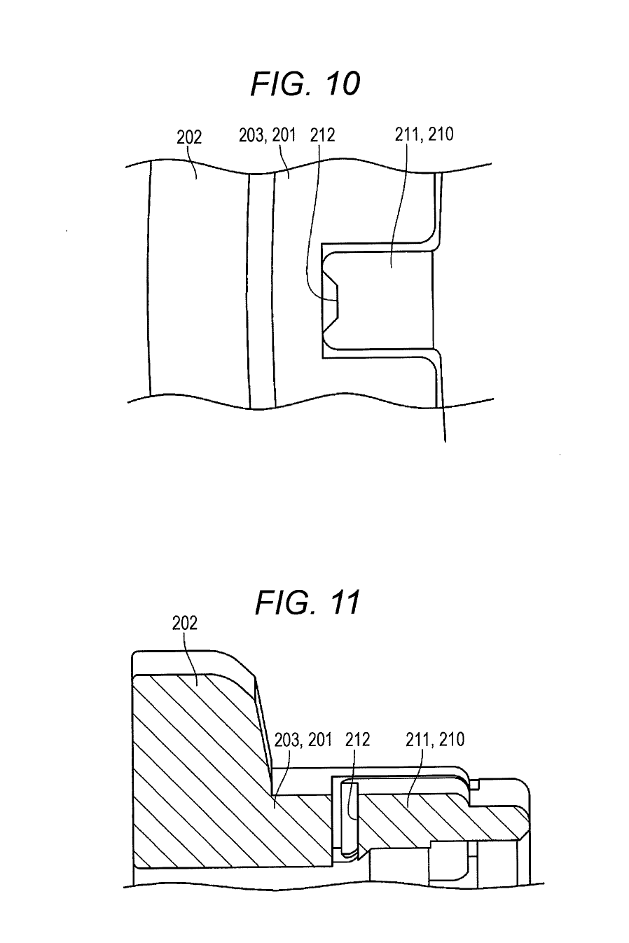

It should be noted that while, in the above-described embodiment, the respective teeth of the regulating comb-teeth part 203 and the supporting comb-teeth part 211 are formed in a rectangular shape, the present invention is not limited thereto. For example, a recess 212 may be formed in each tooth of the supporting member 210, as shown in FIGS. 10 and 11.

With the formation of the recess in such a manner, a void space is created in the recess 212, where the regulating member 200 and the supporting member 210 are opposed to each other when the regulating comb-teeth part 203 and the supporting comb-teeth part 211 completely engage with each other. Due to the creation of the void space, for example, a foreign matter such as paper dust generated from the conveyed paper sheet S, unfixed toner, abrasion powder due to sliding friction, and dust enters the void space.

Since such a foreign matter hinders the movement of the regulating member 200, for example, in a configuration without the recess 212, failures may be caused. Examples of conceivable failures include the following: the regulating member 200 does not operate in a desired manner; the frictional resistance during the movement of the regulating member 200 increases; and the fixing belt 61 locally swells.

However, with the recess 212 provided as described above, it is possible to reduce failures to be caused by the foreign matter, by allowing the foreign matter to enter the void space.

In addition, it is necessary to provide a clearance between the respective members so as to enable the regulating member 200 to smoothly move. When providing the clearance, it is preferable to create the void space of a size enough to stably obtain the effect of allowing the foreign matter to enter the void space even if the dimensions of the members fluctuate within a range of a tolerance.

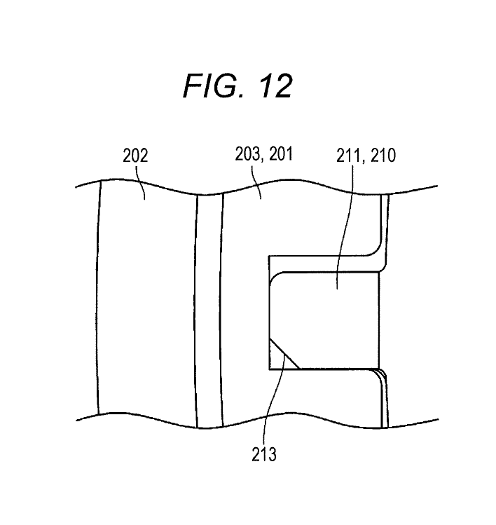

Furthermore, the void space is not limited to the recess 212. For example, a notch 213 formed in the supporting comb-teeth part 211, as shown in FIG. 12, may serve as the void space where the foreign matter is allowed to enter. In addition, it is possible to create the void space where the foreign matter is allowed to enter, by forming something like a recess or notch in the regulating comb-teeth part 203.

Moreover, it is desirable to create the void space of a size sufficient for the foreign matter to enter even when the regulating member 200 and the supporting member 210 thermally expand. In other words, it is desirable to set the size of the void space on the assumption of the thermal expansion of the regulating member 200 and the supporting member 210. In the fixing part 60, there is a possibility that the regulating member 200 and the supporting member 210 thermally expand and deform depending on the amount of heating by the heating roller 62. When the regulating member 200 and the supporting member 210 thermally expand to fill the void spaces, there is a possibility that failures may be caused by the foreign matter. Therefore, it is possible to reduce the occurrence of the failures by forming the regulating member 200 and the supporting member 210 in a shape determined in consideration of the thermal expansion.

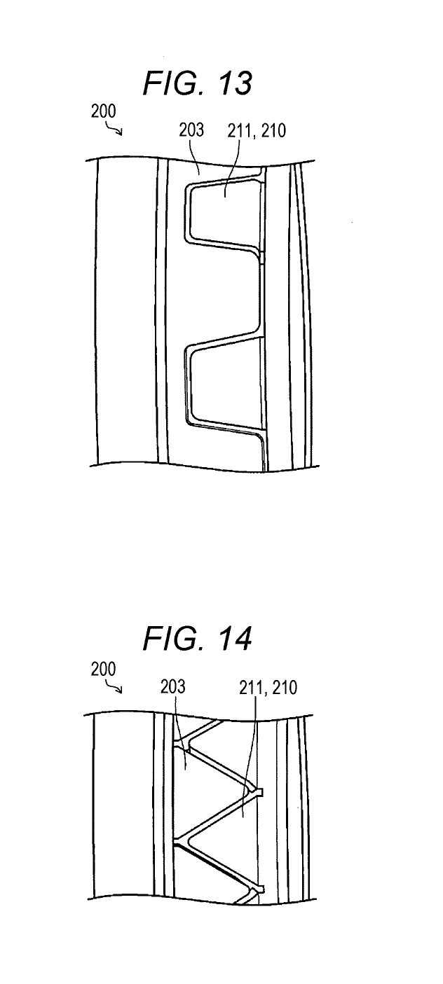

In addition, each tooth of the regulating comb-teeth part 203 and the supporting comb-teeth part 211 may be formed in a manner to be narrower toward the end, as shown in FIG. 13. Thus, it is possible for the regulating comb-teeth part 203 to smoothly move with respect to the supporting comb-teeth part 211.

Moreover, each tooth of the regulating comb-teeth part 203 and the supporting comb-teeth part 211 may be formed in a triangular shape, as shown in FIG. 14. Thus, it is possible to prevent the ends of the regulating member 200 and the supporting member 210 from being caught by each other when the regulating member 200 and the supporting member 210 separate from each other and arrive at positions with a gap therebetween in the width direction, where neither the regulating member 200 nor the supporting member 210 exists.

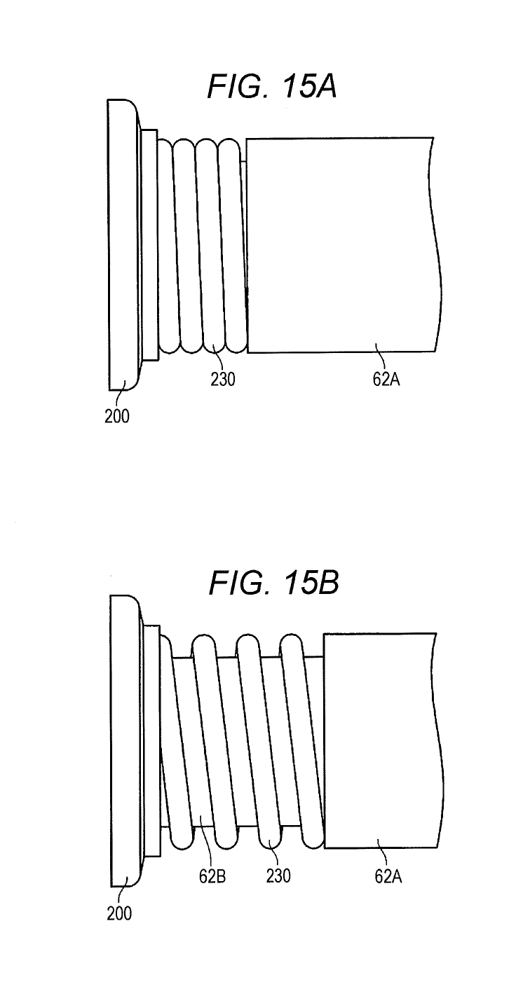

Furthermore, although the supporting member 210 includes the supporting comb-teeth part 211 in the above-described embodiment, the present invention is not limited thereto. For example, the supporting member 210 may be configured to expand and contract in the width direction, as shown in FIGS. 15A and 15B.

For example, the supporting member 230 is formed of a spring capable of expanding and contracting in the width direction, as shown in FIGS. 15A and 15B. The supporting member 230 expands and contracts as the regulating member 200 moves. Accordingly, it is possible to prevent the fixing belt 61 from entering and buckling in the area extending in the width direction between the regulating member 200 and the main body 62A since the fixing belt 61 can be supported by the supporting member 230.

It should be noted that an elastic member, such as rubber and sponge, may be adopted as the supporting member 230. In addition, the supporting member 230 and the regulating member 200 may be separately or integrally formed.

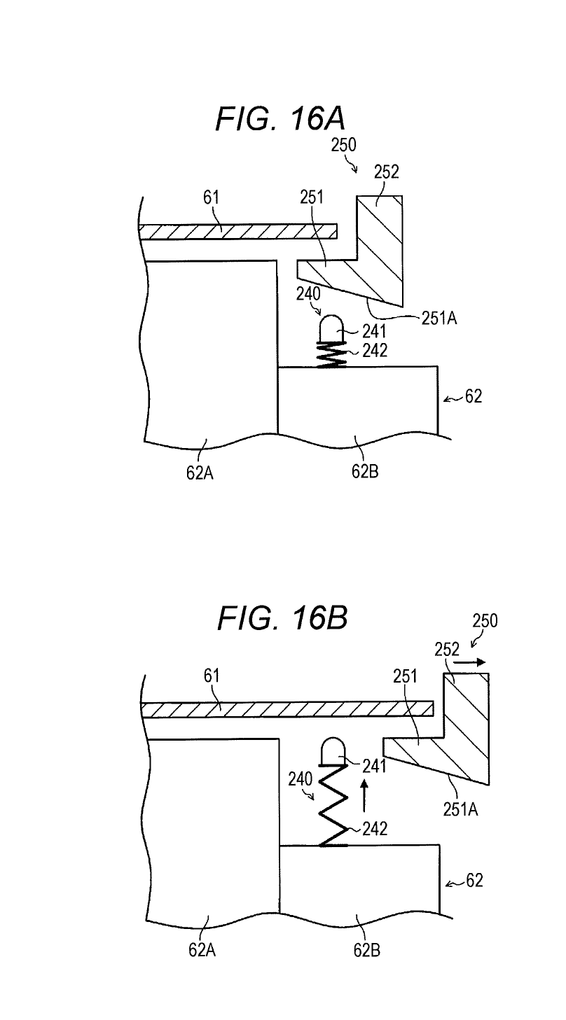

Moreover, in the above-described embodiment, the supporting member is constantly disposed at a position where the supporting member can support the fixing belt 61. However, the present invention is not limited thereto. For example, as shown in FIGS. 16A and 16B, the supporting member 240 may be configured to be movable between a non-supporting position where the supporting member 240 cannot support the fixing belt 61 (see FIG. 16A) and a supporting position where the supporting member 240 can support the fixing belt 61 (see FIG. 16B).

In the present configuration, the regulating member 250 includes a belt supporting part 251 and a regulating part 252. The belt supporting part 251 is a part for supporting the fixing belt 61, and is located below the fixing belt 61.

The regulating part 252 is a part rising upward from an end of the belt supporting part 251 opposite to an end facing the main body 62A, and regulates the movement of the fixing belt 61 in the width direction.

The lower surface of the belt supporting part 251 is an inclined surface 251A which inclines downward as going outward in the width direction.

The supporting member 240 includes a supporting part 241 and a biasing part 242. The supporting part 241 is a part for supporting the fixing belt 61, and is capable of contacting the fixing belt 61 and the inclined surface 251A. The biasing part 242 is a spring that biases the supporting part 241 upward.

In the present configuration, when the regulating member 250 moves toward the main body 62A, the supporting member 240 is pushed down and moved, by the inclined surface 251A, to the non-supporting position where the supporting member 240 cannot support the fixing belt 61. Meanwhile, when the regulating member 250 moves away from the main body 62A, the supporting member 240 is released from the pressing action by the inclined surface 251A, and moves to the supporting position between the main body 62A and the regulating member 250 due to a biasing force by the biasing part 242. Then, the supporting part 241 supports the fixing belt 61.

Furthermore, in the above-described embodiment, when the regulating comb-teeth part 203 and the supporting comb-teeth part 211 on one side completely engage with each other, those on the other side partially engage with each other only at their tips. However, the present invention is not limited thereto. For example, the regulating member 200 may be moved to such an extent that a gap is created between the teeth of the regulating comb-teeth part 203 and those of the supporting comb-teeth part 211 in the width direction. However, it is necessary to limit the width of the gap within a certain range so as not to allow the fixing belt 61 to enter the gap.

Additionally, in the above-described embodiment, the moving mechanism 220 includes the rack gear 221 and the pinion gear 222. However, the present invention is not limited thereto. For example, the moving mechanism may be a cam mechanism, a crank mechanism, or a mechanism using a ball screw or the like.

Moreover, both of the pair of regulating members 200 are simultaneously moved in the above-described embodiment. However, the present invention is not limited thereto. It is also possible to allow either one of the pair of regulating members 200 to move.

In addition, the fixing part 60 has been cited as an example of the belt conveying apparatus in the above-described embodiment. However, the present invention is not limited thereto. For example, an apparatus, such as a transfer apparatus and a paper conveying apparatus, may serve as the belt conveying apparatus as long as the apparatus includes an endless belt member and a belt conveying roller.

Furthermore, any aspect of the above-described embodiment is merely a specific example of the implementation of the present invention. The technical scope of the present invention should not be interpreted in a limited manner by the embodiment. That is, the present invention can be implemented in various forms without departing from the gist or major characteristics thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A belt conveying apparatus comprising:
an endless belt member;
a belt conveying roller that rotatably stretches the belt member;
a pair of regulating members, disposed at both end parts of the belt conveying roller, that regulates movement of the belt member in a width direction thereof;
a moving mechanism that moves at least one of the pair of regulating members in the width direction; and
a supporting member that supports the belt member in an area extending in the width direction after the regulating member has moved.

2. The belt conveying apparatus according to claim 1, wherein
the moving mechanism simultaneously moves both of the pair of regulating members.

3. The belt conveying apparatus according to claim 1, wherein
the regulating member has a regulating comb-teeth part formed on a side facing the supporting member, and
the supporting member has a supporting comb-teeth part, formed on a side facing the regulating member, that is capable of engaging with the regulating comb-teeth part.

4. The belt conveying apparatus according to claim 3, wherein
each tooth of the regulating comb-teeth part and the supporting comb-teeth part is formed in a manner to be narrower toward an end thereof.

5. The belt conveying apparatus according to claim 1, wherein
the supporting member is capable of expanding and contracting in the width direction of the belt member.

6. The belt conveying apparatus according to claim 1, wherein
the supporting member moves to a non-supporting position where the supporting member is incapable of supporting the belt member when the regulating member moves inward in the width direction, and
the supporting member moves to a supporting position where the supporting member is capable of supporting the belt member when the regulating member moves outward in the width direction.

7. The belt conveying apparatus according to claim 1, wherein
void spaces are created at positions where the regulating member and the supporting member are opposed to each other, so as to allow foreign matters to enter.

8. The belt conveying apparatus according to claim 7, wherein
the belt conveying roller includes a heating source, and
a size of the void space is set on an assumption of thermal expansion of the regulating member and the supporting member.

9. The belt conveying apparatus according to claim 1, wherein
spaces and the supporting member are disposed in the area after the regulating member has moved, in a circumferential direction of the belt conveying roller.

10. An image forming apparatus comprising:
the belt conveying apparatus according to claim 1.
